(19) United States
(12) Patent Application Publication
(10) Pub. No.: US 2006/0108417 A1
(43) Pub. Date: May 25, 2006

(54) Appliance payment system

(75) Inventors: Franklin C. Simon, Hollywood, FL (US); Michael P. Simon, Hemet, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Payment Protection Systems, Inc., Temecula, CA (US)

(21) Appl. No.: 11/257,121

(22) Filed: Oct. 25, 2005

Related U.S. Application Data
(60) Provisional application No. 60/621,807, filed on Oct. 26, 2004.
(60) Provisional application No. 60/621,074, filed on Oct. 25, 2004.

(51) Int. Cl. G06K 5/00

(52) U.S. Cl. 235/382

(57) ABSTRACT

An exemplary appliance control system for controlling an appliance includes a controller located inside the appliance, wherein the controller comprises a switch arranged between the electric power source and the appliance power supply and a receiver, a payment control center, and a payment control module comprising a transmitter for communicating with the controller receiver and a modem for communicating with the payment control center via a communication network. Another exemplary appliance control system includes a switch located between an electrical power source and an electrical power socket that provides electrical power to the appliance, a payment control center, and a payment control module that communicates with the switch and the payment control center, wherein the payment control module instructs the switch to open when the payment control center indicates that a finance payment for the appliance is past due.

This application claims priority under 35 U.S.C. § 119(e) to U.S. Provisional Applications No. 60/621,807 and No. 60/621,074, filed in the U.S. Patent and Trademark Office on 26 Oct. 2004 and 25 Oct. 2004 respectively. U.S. Provisional Applications No. 60/621,807 and No. 60/621,074 are hereby incorporated by reference in their entirety.

### BACKGROUND OF THE INVENTION

1. Field of the Invention

The present invention relates to an appliance control system. More specifically, the appliance control system is integrated with and communicates with a payment control system.

2. Description of the Related Art

Obtaining payment for appliances, whether rented or purchased, is often a difficult chore. A system for effectively and efficiently controlling an appliance in connection with timely payments would be of great benefit to the appliance industry. The typical techniques involving phone calls, threats, physical repossession involves a great deal of inefficiencies. Improving on such techniques would be welcome to the industry.

### SUMMARY OF THE INVENTION

The present invention involves an appliance control system for controlling an appliance which includes a controller located inside the appliance, wherein the controller comprises a switch arranged between the electric power source and the appliance power supply and a receiver, a payment control center, and a payment control module comprising a transmitter for communicating with the controller receiver and a modem for communicating with the payment control center via a communication network.

In another embodiment, the appliance control system includes a switch located between an electrical power source and an electrical power socket that provides electrical power to the appliance, a payment control center, and a payment control module that communicates with the switch and the payment control center, wherein the payment control module instructs the switch to open when the payment control center indicates that a finance payment for the appliance is past due.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements.

FIG. 1 illustrates exemplary systems and embodiments.

### DETAILED DESCRIPTION OF THE PREFERRED EMBODIMENTS

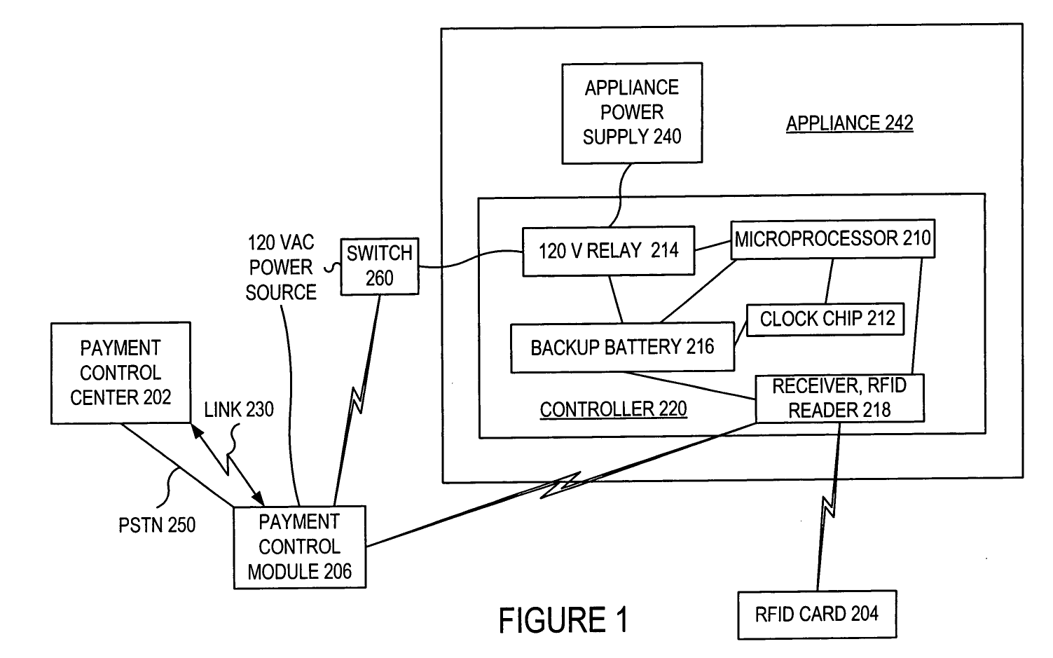

FIG. 1 illustrates several exemplary embodiments. As shown in FIG. 1, an appliance 242 connects to a 120 volt alternating current power source. In a first embodiment, a payment control module 206 communicates with a controller 220 that is located within the appliance 242. The controller 220 can include a switch or relay 214 located between the power source and an appliance power supply 240, so that the controller 220 can effectively turn off the appliance 242 via the switch or relay 214, for example in accordance with instructions (or lack of instructions) received from the payment control module 206. The payment control module 206 also communicates with a payment control center 202, which can inform the payment control module 206 when a finance payment or other financial obligation or limitation relating to the appliance 242 is due or expired so that the payment control module 206 can instruct the controller 220 to control the switch or relay 214 accordingly. For example, in the event the payment control center 202 indicates that a payment is overdue, then the payment control module 206 can instruct the controller 220 to open the switch or relay 214 and thus turn off and disable the appliance 242. Conversely, in the event the payment control center 202 informs the payment control module 206 that an interim or full payment has been received, then the payment control module 206 can instruct the controller 220 to close the switch or relay 214 and thus enable the appliance 242 for a period of time corresponding to the payment. If the payment satisfies the full financial balance due for the appliance 242, then the controller 220 can permanently close the switch or relay 214. The payment control module 206 can communicate with the payment control center 202 via a public switch telephone network 250, or via a wireless link 230 such as a cellular communication link. The payment control module 206 can include any equipment necessary or desirable to support or enable this communication, including but not limited to a modem, a transceiver, and so forth. These same principles apply reciprocally to the payment control center 202. The payment control module 206 can communicate via a wireless link with the controller 220, and in exemplary embodiments can communicate with the controller 220 by sending control signals over an alternating power source connected to both the payment control module 206 and the appliance 242 and controller 220. For example, X10 power line carrier technology can be used to transmit data or control signals over power line wiring. In exemplary embodiments, the payment control module 206 can instruct the controller 220 to open the switch or relay 214 in the event the payment control module 206 is unable to communicate with the payment control center 202, and thus forestall a situation where a user of the appliance attempts to tamper with the system by severing or interfering with communications between the payment control module 206 and the payment control center 202. In addition, similar principles or techniques can be applied with respect to communications between the payment control module 206 and the controller 220 for similar reasons. In particular, the controller 220 can be configured so that if it does not receive a communication from the payment control module 206 within a predetermined interval of time, then the controller 220 can automatically open the switch or relay 214 and disable the appliance 242 until communication between the controller 220 and the payment control module 206 is restored.

In another exemplary embodiment, the controller 220 further includes a backup battery 216, a clock chip 212, a microprocessor 210 and a receiver 218 that can function as a radio frequency identification reader to read data from an RFID card 204. The microprocessor 210 can coordinate activity of the controller 220, for example. The backup battery 216 allows the controller 220 to continue functioning in the event a user of the appliance unplugs the appliance 242 from the 120 volts AC power source, and the clock chip 212 enables the controller 220 to keep track of time intervals and passage of time. In this embodiment, the controller 220 can receive account balance, payment, or other ownership or code information that may form a basis for enabling or disabling the appliance 242 via the relay or switch 214 for a period of time, permanently, or until further notice. For example, when a user purchases the appliance, an RFID card can be provided at that time with a code that requests the controller 220 to enable the appliance for a specified period of time, for example six months or one year based on for example an option or payment purchase plan purchased by the user at the time the appliance was purchased. The RFID card 204 can also for example be equipped with a code that instructs the controller 220 to permanently enable the appliance 242, for example when the user provides payment in full at the time the appliance is purchased, or provides remaining required payment at a later date and receives an RFID card or information update to an existing RFID card containing codes to permanently enable the appliance 242. Additional information can be conveyed by the RFID card 204 to the controller 220, for example information identifying the user or owner of the appliance, appliance identification information to uniquely identify a particular appliance and/or identify or correspond to a model or a class of appliances, and/or any other necessary or desirable information to establish a relationship between the RFID card 204 and the appliance 242 and authenticate or secure that relationship. The RFID capability can be provided alternatively or in addition to other capabilities for example wireless or wired links to the payment control module 206 and thus indirectly to the payment control center 202.

In another exemplary embodiment a switch 260 is provided between a power source and a power receptacle to which the appliance 242 is connected, for example within a room of a building. In this embodiment, the payment control module 206 controls operation of the switch 260, for example via a wireless link or by transmitting control signals over power lines common to both the payment control module 206 and the switch 260. In this embodiment, operation of the payment control center 202 and the payment control module 206 operate in the same fashion described elsewhere herein, but the switch being controlled is external to the appliance 242 rather than internal. Such a configuration can be used, for example, in a rental apartment setting, where a renter rents not only a living space but also appliances within the living space. If a renter is delinquent in making payments for such services or if a prepaid duration of those services expires, as tracked, for example, by the payment control center 202, then the payment control module 206 can turn off selected switches 260 based on information received from the payment control center 202. When payments are renewed or timely paid, then the switch 260 and thus any appliance drawing power from the receptacle which the switch controls, is then enabled.

Those skilled in the art will recognize that various adjustments or configurations can be applied. For example, the payment control module 206 can be plugged into a telephone jack to enable communication between the payment control module 206 and the payment control center 202 via conventional telephone lines. Warning signals of various types can be provided to the appliance user or owner to signal impending expiration of a prepaid time period or impending expiration of a grace period for tendering a finance or installment payment. These warnings can include, for example, audible signals such as beeps whose tone, pitch, volume or other distinctive characteristic(s) are noticeably modulated as the deadline approaches. Visual warning signals can also be provided, for example, by lights with different colors or a progression from one color to another indicates proximity to the deadline, frequency of flashing and/or intensity or brightness can also indicate nearness of the deadline. One or more of the payment control center 202 to the payment control module 206 and a controller 220 can actively seek to establish periodic communication with one another and/or passively listen for a communication from one another and then open the switch or relay 214 or the switch 260 or send signals to command such opening in the event that periodic communications are interrupted, and thus forestall tampering by the user or owner of the appliance with the control system. The controller 220 is shown with a backup battery 216, and the payment control module 206 can additionally or alternately be provided with a backup power source. In the event external powers interrupted to either or both of the controller 220 and the payment control module 206, those devices can presume that interruption of the power supply is due to tampering and can then instruct the switch 260 and/or the switch or relay 214 to open and disable the appliance 242 until power is restored or some other condition is satisfied, for example, a special code is entered or provided to the payment control module 206 and/or the controller 220 by the user or owner via user interfaces provided at the appliance 242 and/or the payment control module 206. Alternatively or in addition, a payment control center 202 can provide a reactivation code or instruction to the payment control module 206 to reactivate the appliance 242, for example, after the owner or user of the appliance has contacted a customer representative or a customer service machine to explain or clarify the power interruption.

In an exemplary embodiment, the payment control module 206 periodically initiates a call to the payment control center 202, and automatically logs into an account for the appliance 242, for example, by providing an account number associated with the appliance 242, to discern a status of the account and then disable, enable, or continue enabling the appliance 242 based on the determined status. In an exemplary embodiment, for devices that require periodic maintenance at specified time intervals, the control system shown in FIG. 1 can be used to disable the appliance 242 and upon expiration of a maintenance interval so that the appliance is not used until the necessary or desired periodic maintenance is performed.

In an exemplary embodiment, the backup battery 216 has sufficient power to operate the clock chip 212 for approximately one year. A programmable RFID card can be programmed with a current date and time as well as a serial number of the appliance, for example, at the time the appliance is purchased. When the controller 220 is powered up, for example by first turning on the appliance 242 or by another predetermined sequence of events such as pressing particular buttons of the appliance 242 in a particular sequence or any other operational sequence applied to the appliance 242, the controller 220 can be initially activated and the RFID card can be placed within range of the RFID reader 218 to program the controller 220 with a proper date, time and serial number of the appliance. The microprocessor 210 can include memory storage capacity and/or the controller 220 can include additional data storage capacity in the form of flashcards or other data storage device or capacity. Programming of the controller can occur before the controller is installed in the appliance, at the factory. When the appliance is sold to a customer, the customer can receive a store payment credit card which can also be an RFID programmable memory card having an internal portion of its code that matches the serial number of the appliance. The customer RFID card can be programmed at the time of appliance purchase, or at a later date, to shut off the appliance at a particular date and time, for example in accordance with an amount of payment provided by the customer and/or a service contract or promotional offer entered into or accepted by the customer. Then, the customer takes the appliance home, plugs it in and turns it on. The customer can then present the customer RFID card to the RFID reader 218 so that information regarding when the appliance is to be shut down is transferred from the RFID card 204 to the controller 220. In an exemplary embodiment, three days before the scheduled shutoff date, an LED indicator light can flash three times in succession. Two days prior to the shutoff date, the LED indicator can flash two times in succession. One day before shutoff, the LED indicator can flash once. On the day of shutoff, the LED light can remain continuously lit and the controller can disconnect power to the appliance power supply 240 and thus disable the appliance 242. At this stage, the customer can return to a store or access a website and make a payment for the appliance. In response, the customer's RFID card is reprogrammed with a new shutoff date, for example by service personnel at the store the customer visited, or via a code provided via internet. In an exemplary embodiment, a new customer RFID card can be mailed to the customer. After the RFID customer card is reprogrammed with a new shutoff date, the customer can then present the card to the RFID reader 218 of the controller 220 to cause the controller 220 to enable the appliance 242 until a next shutoff date. At the end of the payment period, the customers RFID card can be programmed with a system disable code so that the appliance will no longer be controlled by the controller 220, and the switch or relay 214 will be permanently closed to permanently enable the appliance 242.

Software packages, elements or modules for variously providing the functions described herein, can be implemented on a computer. These software processes running on the computer can additionally or alternatively be implemented in a distributed fashion external to the network using for example distributed computing resources, and/or can be implemented using resources of the network.

The methods, logics, techniques and pseudocode sequences described herein can be implemented in a variety of programming styles (for example Structured Programming, Object-Oriented Programming, and so forth) and in a variety of different programming languages (for example Java, C, C++, C#, Pascal, Ada, and so forth). In addition, those skilled in the art will appreciate that the elements and methods or processes described herein can be implemented using a microprocessor, computer, or any other computing device, and can be implemented in hardware and/or software, in a single physical location or in distributed fashion among various locations or host computing platforms. Agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

A machine readable medium can include software or a computer program or programs for causing a computing device to perform the methods and/or techniques described herein.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein. The term “comprising” as used herein is open-ended and not exclusive.

What is claimed is:

1. An appliance control system for controlling an appliance, comprising:
a controller located inside the appliance, wherein the controller comprises a switch arranged between the electric power source and the appliance power supply and a receiver;
a payment control center; and
a payment control module comprising a transmitter for communicating with the controller receiver and a modem for communicating with the payment control center via a communication network.

2. The system of claim 1, wherein the communication network is a public switched telephone network.

3. The system of claim 1, wherein the payment control module communicates periodically with the payment control center and with the controller, and wherein the payment control module instructs the controller to open the switch to disconnect the appliance power supply from the electric power source when the payment control module is unable to communicate with the payment control center within a predetermined time interval or the payment control center indicates to the payment control module that a finance payment for the appliance is delinquent.

4. The system of claim 1, wherein:
the controller comprises a Radio Frequency IDentification reader; and
the controller keeps the switch closed for a time interval corresponding to a balance value on a Radio Frequency IDentification card read by the reader.

5. The system of claim 4, wherein the controller permanently closes the switch when the reader receives a predetermined code from a Radio Frequency IDentification card.

6. An appliance control system for controlling an appliance, comprising:
a switch located between an electrical power source and an electrical power socket that provides electrical power to the appliance;
a payment control center; and
a payment control module that communicates with the switch and the payment control center, wherein the payment control module instructs the switch to open when the payment control center indicates that a finance payment for the appliance is past due.

7. The system of claim 6, wherein the payment control module sends control signals to the switch via an alternating current electrical power network connected to both the payment control module and the switch.
